(19) United States
(12) Patent Application Publication
(10) Pub. No.: US 2004/0037244 A1
(43) Pub. Date: Feb. 26, 2004

(54) Cellular radio telecommunication systems

(76) Inventors: Nicholas Dougall Johnson, London (GB); Andrew Fogg, Sandy (GB); John Leslie Haine, Cambridge (GB); Neil Philip Piercy, Royston (GB)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/415,695

(22) PCT Filed: Oct. 23, 2001
(86) PCT No.: PCT/GB01/04708

(30) Foreign Application Priority Data
Oct. 31, 2000 (GB) 0026584.3

(51) Int. Cl. H04Q 7/00

(52) U.S. Cl. 370/330; 370/478

(57) ABSTRACT

A cellular radio telecommunication system is described that allows the beacon frequencies in the system that distributes the common control channel to carry more traffic channels than the number of remaining TDM slots, by reusing the same slot in different parts of the network to carry different traffic to different mobiles. This is achieved by monitoring the location in the network of each mobile which is assigned to a traffic channel on the beacon frequency, using a controlling agent, and ensuring that any basestation assigned to the beacon frequency which is sufficiently close to this mobile transmits exactly the same data in the slot carrying this traffic channel, but otherwise allows the slot to be reallocated.

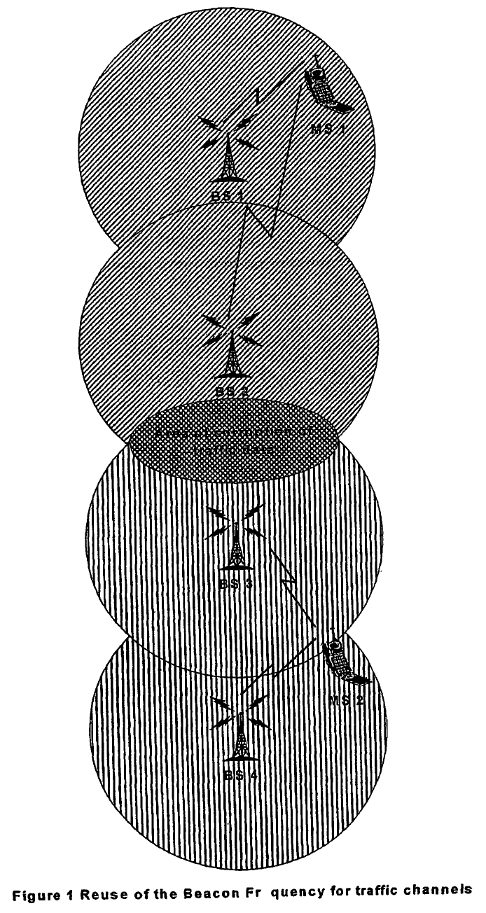

This invention relates to cellular radio telecommunication systems, and especially private systems and their adaptation to work with public cellular radio telecommunication systems.

Cell planning and frequency reuse within a cellular network become more and more difficult as the traffic density rises and the cell size falls. This is especially so for outdoor basestations covering indoor users, firstly because of reduced propagation loss (from fourth power to square law) with reduced propagation distance, resulting in increased spillover beyond nominal cell boundaries, and because of the insertion loss of walls, ceilings and other obstructions, which require increased power operation from both basestations and mobiles. These two factors increase the so-called “co-channel interference” problem, which is to say, the increase in interference from nearby cells and mobiles operating on the same frequency channels. Channels can only be reused at greater and greater distances. Even with private indoor networks supplying indoor coverage, the extremely small size of the cells (less than 50 m diameter) can result in a demand for channels greater than the public operators can provide.

One possible solution to this problem is to use a repeater, which carries the signal into a building where it is most needed. In this way, the power levels for both mobile and basestation can be kept low, and the co-channel interference problem is reduced. The drawback of using repeaters is that they offer no new capacity; they simply bring existing capacity closer to where it is needed. In commonly accepted scenarios where mobile usage will be moving indoors, this approach will not offer the required channel capacity.

Another approach to the problem is to use a technique called Intelligent Underlay-Overlay (IUO), which reuses spectrum differently, depending on its use. In this technique, GSM beacon frequencies (carrying the so-called Basestation Control Channel or BCCH) are reused in a low density pattern, to ensure low interference between beacons, and an extremely low probability of error on these broadcast channels. Traffic channels are reused in a higher density pattern, to provide high capacity at the expense of some interference. The attraction of this scheme is the high spectral efficiency of the telephony traffic.

Although use of a repeater is a viable option for low capacity indoor coverage to ameliorate the co-channel interference problem, the cost of providing this coverage by repeater technology rises unacceptably as the indoor traffic rises. Other micro-cellular techniques using micro- and pico-basestations may be used such as “distributed antenna” technology; for example, a “leaky feeder”, such as a length of coaxial cable with openings made in its outer screen to allow RF energy in and out of the cable. Losses in the cable, its high cost and generally high installation overhead restrict this technology to short cable runs. Other examples use optical fibre to transport the RF and modulate the RF on and off the fibre at special RF head units. Though suitable for long cable runs, the high cost of the optical fibre and the modulation and demodulation RF head units restricts the applicability of this technology. Yet other examples, distribute the RF at a lower, intermediate frequency (IF), and heterodyne this up to the required band at special RF head units. Since the distribution is done at IF, the cable runs may be long and the cable cheap, but again the requirement for specialised RF head units adds cost to the technique.

An object of the invention is to provide an improved cellular radio telecommunication system suitable for in-building coverage, compatible with an external public cellular network and existing unmodified mobile terminals.

According to our previous invention forming the subject of patent application GB0017429.2, a network of basestations is controlled in such a manner that the basestations use a single broadcast synchronised control channel and separately handle dedicated traffic and signalling channels in their immediate vicinity. Such a network of basestations requires the beacon frequencies that carry the control channel to carry exactly the same data so that mobiles at any point within the network may detect the beacon and use the common control channel.

Because a common control channel is broadcast by multiple basestations, each basestation can transmit at a lower power and thus interference with the external micro network is reduced.

In order that the over-the-air frame structure transmitted (and received) in the coverage area of the network is time synchronised for all mobile subscriber units, it is necessary to synchronise the basestations to within a few bit periods (each bit period is approximately 4 μs in GSM). It is not required to synchronise the basestations more closely than this (though it may be convenient to do so) since mobile subscriber units are designed to deal with signals arriving with timing differences of this order. For example, GSM mobiles have an equaliser which can detect two signals in a multipath channel, with delay spreads of several bit periods. In contrast, normal GSM and other cellular networks, do not require that basestations should be synchronised with each other.

Thus, it will be appreciated that a mobile subscriber unit moving within the network of basestations will receive time-delayed copies of the control data from each basestation, but that the equaliser within the mobile subscriber unit will treat these as multi-path copies and reconstruct them in the usual manner. The mobile subscriber unit will therefore see the network of basestations as a single cell.

However, in TDMA systems, such as GSM, the beacon frequency may be used to carry several channels in a TDM manner, and typically carry the control channel in only one of the several TDM slots on that frequency, the others being available for assignment as traffic channels. Also, it is commonly required, as in GSM, that the beacon frequency is always transmitted in all slots, with idle data patterns as necessary even if they are not being used for traffic, so as to allow a mobile to detect the presence of the carrier frequency and to assess its signal strength even if the mobile is not synchronised to its repeating TDM frame structure (e.g. to allow the mobile to determine if it has moved away from its existing cell and into a new cell).

One problem with distributing the beacon frequency across several basestations to allow a single common control channel across the whole area of the distributed set of basestations is that the remaining timeslots on the beacon frequency which may be used for carrying traffic are similarly distributed. This results in the beacon frequency having no more capacity (in terms of traffic carried per frequency over the whole site) in this system than it does in a distributed antenna or conventional BTS.

The nub of the problem is that all timeslots of the beacon frequencies must be transmitted on all basestations which are required to broadcast the common control channels. It is possible on non-beacon frequencies to transmit the traffic only on the BTS or BTSs in the immediate vicinity of the mobile, to have those BTSs in the surrounding area not use the same channel to prevent interference with the traffic, and to have one or more BTSs yet further away reuse the same channel to supply traffic to a different mobile local to it. This is like a standard cellular reuse of traffic frequencies, but scaled down to the indoor coverage and reuse scales. The beacon frequency cannot however have such a non-transmitted “buffer zone” between reuse: it must be transmitted at the same signal strength on all timeslots from all BTSs which are needed to carry the common control channels, and must be decodeable everywhere within the coverage area of the “distributed BTS”. Thus any differences between the data transmitted by two different BTSs will cause interference between the two of them, and prevent mobiles receiving both of the transmissions from being able to decode them correctly.

This invention is applicable to TDMA systems such as GSM systems.

The invention overcomes this limitation, and allows the beacon frequencies in a system which distributes the common control channel to carry more traffic channels than the number of remaining TDM slots, by reusing the same slot in different parts of the network to carry different traffic to different mobiles.

This is achieved by monitoring the location in the network of each mobile which is assigned to a traffic channel on the beacon frequency, using a controlling agent, and ensuring that any basestation assigned to the beacon frequency which is sufficiently close to this mobile transmits exactly the same data in the slot carrying this traffic channel, but otherwise allows the slot to be reallocated. When another mobile in another part of the network also requires a traffic channel, it may be assigned a traffic channel on the same slot on the beacon frequency provided that it too may be surrounded by basestations sufficiently close to it carrying exactly the same data so as not to interfere with the traffic to this mobile. Provided the mobiles are sufficiently separated, both may be surrounded by basestations carrying identical data to that which it requires, and thus not interfere with each other.

It should be noted that this is very different from the standard re-use of traffic channels on non-beacon frequencies. In the case of non-beacon frequencies, the area between the closest re-use of the same frequency (and if the network is synchronised, same TDM slot) has no transmitters using that frequency: monitoring the frequency between the two islands of usage would detect weak interfering signals from each of the areas of usage. In the case of beacon frequencies, the area between the closest re-use of the same frequency and TDM slot (for the network of the invention is synchronised) has transmitters using that frequency which are transmitting information identical to one or other of the traffic channels, according to which area of usage they are closest to: monitoring the frequency between the two islands of usage would detect normal strength but interfering signals from each of the areas of usage. The implication of this is that the reuse of the channels on the beacon frequency must be on a reuse pattern which does not lead to as frequent a reuse as may be achieved for the non-beacon frequencies, but nevertheless for large distributed basestation networks it is important to achieve the highest capacity from the smallest number of frequencies.

It should also be noted that the slot carrying the control channel on the beacon frequencies is unaffected by this invention: all transmissions of this slot carry identical control data so that it is receivable and decodeable at all points in the coverage area of the distributed basestations. Further, the requirement that the mobiles be able to receive constant signal strength at all times on the beacon frequency is also unaffected: all timeslots on the beacon frequency are transmitted on all basestations carrying the beacon frequency at equal signal strength.

The invention will now be described by way of example with reference to the accompanying schematic drawings of a GSM cellular radio telecommunication system according to the invention.

Consider the synchronised distributed basestation network shown in the drawing. In this example, each basestation BS contains one transceiver (TR/RX). All the basestations are transmitting a synchronised broadcast channel according to our patent application GB0017429.2, and only those basestations configured to transmit the beacon frequency are illustrated. As described in the previous patent application, all these BSs are configured to transmit the same beacon frequency, and transmit identical information on the common control channels within this beacon frequency.

Such a network, is similar to a repeater network. It provides good coverage at minimum interference, but only 7 channels of traffic capacity for the whole network. In order to increase its traffic capacity extra transceivers (TX, RX pairs) may be added at some or all of the basestations, and a controller PC is provided according to the previous invention which is connected to the basestations via a packet-switched local area network LAN to direct traffic by the “least interference” route through the network, the controller incorporating a “mobility management agent” MMA, which gives it this functionality. However the beacon frequency would still only carry the 7 traffic channels, as it would be transmitting identical data at each of BS1 . . . BS4.

As a result of applying this invention, the MMA is able to allocate the same traffic channel on the beacon frequency (i.e. same TDM slot) to both MS1 and MS2, and to transmit the data relevant to MS1 on both BS1 and BS2, and to transmit the data relevant to MS2 on both BS3 and BS4. The area in which BS2 and BS3 overlap suffers from corruption of this TDM slot due to the differences between the data for MS1 and that for MS2, but the MMA has knowledge of the location of both MS1 and MS2 relative to the BSs, and thus evaluates that the reuse of the traffic channel is acceptable. Any MSs within this area of corruption still receive uncorrupted BCCH and still receive the correct beacon frequency power levels for its monitoring. This results in the beacon frequency being able to support more than the 7 traffic channels which it would otherwise be able to.

1. A cellular radio telecommunications system comprising:
a first plurality of basestations, each base station capable of transmitting signals on one of a plurality of frequency channels, each said frequency channel comprising a plurality of time division multiplexed signal channels;
a second plurality of basestations comprising a subset of said first plurality of basestations each arranged to transmit a common control signal on the same first signal channel of a first frequency channel; and
a plurality of mobile stations, wherein some of said second plurality of basestations within the locality of one of said mobile stations are each arranged to transmit a traffic signal to said mobile station on a second signal channel of said first frequency channel and other of said second plurality of basestations outside of said locality are arranged to transmit other traffic signals to other of said plurality of mobile stations on said same second signal channel.

2. A cellular radio telecommunications system according to claim 1, wherein transmission of traffic signals by said basestations are controlled by a controlling agent.

3. A cellular radio telecommunications system according to claim 2, wherein said controlling agent is arranged to monitor the location of each of said mobile stations within said system to determine which of said second plurality of basestations are within the locality of each mobile station.

4. A cellular radio telecommunications system according to claim 3, wherein said controlling agent determines the transmission of traffic signals on said second signal channels based on the location of said mobile stations.

5. A cellular radio telecommunications system according any preceeding claim, wherein said telecommunication system is a GSM system.

6. A cellular radio telecommunications system according to claim 5, wherein said common control signal comprises a base station control channel.

7. A cellular radio telecommunications system according to claim 6, wherein said frequency channel on which said base station control channel is transmitted comprises a beacon frequency.

8. A cellular radio telecommunications system according to any preceeding claim, wherein said plurality of basestations are connected to a local area network.

9. A cellular radio telecommunications system according to claim 8 when dependent on any one of claims 2 to 7, wherein said controlling agent is connected to said local area network.

10. A cellular radio telecommunications system according to any preceding claim, wherein said telecommunications system comprises an in-building system.

11. A cellular radio telecommunications system substantially as described herein with reference to, or as shown in, the accompanying figure.
